(19) United States
(12) Patent Application Publication
(10) Pub. No.: US 2011/0085675 A1
(43) Pub. Date: Apr. 14, 2011

(54) Switchable Two-Element Directional Microphone System

(76) Inventor: Timothy Wickstrom, Elk Grove Village, IL (US)

(21) Appl. No.: 12/902,223

(22) Filed: Oct. 12, 2010

Related U.S. Application Data
(60) Provisional application No. 61/250,693, filed on Oct. 12, 2009.

(51) Int. Cl. H04R 3/00

(52) U.S. Cl. 381/92

(57) ABSTRACT

A directional microphone system includes a first microphone that is disposed so as to receive sound energy originating from a first direction, convert the sound energy into a first voltage to be presented at a output. A second microphone is disposed to receive sound energy from a second direction different from the first direction and converts the sound energy into a second voltage presented at a second output. A first amplification circuit provides a first voltage gain at a third output. A second amplification circuit provides a second voltage gain at a fourth output and a predetermined time delay compared to the first amplification circuit. A controlled switch selectively switches a coupling of the first output between the first amplification circuit and the second amplification circuit and vice versa, and the coupling of the second output between the second amplification circuit and the first amplification circuit and vice versa. An output processing circuit is coupled to the first amplification circuit and the second amplification circuit and subtracts the fourth output from the third output such that a generally cardioid-shaped response is provided at its output.

### CROSS REFERENCE TO RELATED APPLICATION

This patent claims benefit under 35 U.S.C. §119(e) to U.S. Provisional Application No. 61/250,693 entitled “Switchable Two-Element Directional Microphone System” filed Oct. 12, 2009 having Attorney Docket Number PO9016 the content of which is incorporated herein by reference in its entirety.

### TECHNICAL FIELD

The present invention relates a microphone array. More particularly, this invention relates to a system for providing unidirectional response.

### BRIEF DESCRIPTION OF THE DRAWINGS

For a more complete understanding of the disclosure, reference should be made to the following detailed description and accompanying drawings wherein:

FIG. 1 is a diagram of a circuit for providing a directional microphone system in an embodiment of the present invention;

FIG. 2 is a diagram of a sound pattern produced by a directional microphone system in an embodiment of the present invention;

FIG. 3 is a diagram of the system of FIG. 1 implemented within an automobile; and

FIG. 4 is a diagram of the element frequency response and array frequency response for the directional microphone system of FIG. 1.

### DETAILED DESCRIPTION

While the present disclosure is susceptible to various modifications and alternative forms, certain embodiments are shown by way of example in the drawings and these embodiments will be described in detail herein. It will be understood, however, that this disclosure is not intended to limit the invention to the particular forms described, but to the contrary, the invention is intended to cover all modifications, alternatives, and equivalents falling within the spirit and scope of the invention defined by the appended claims.

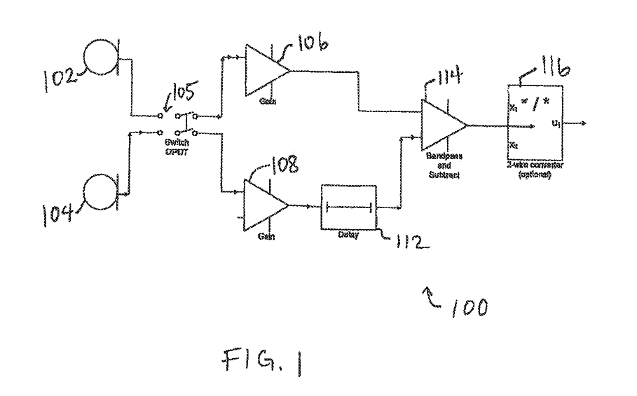

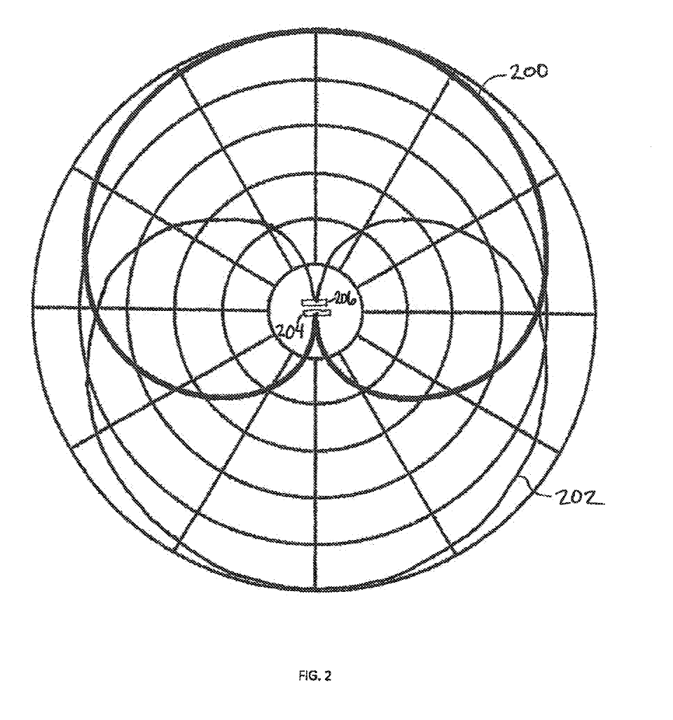

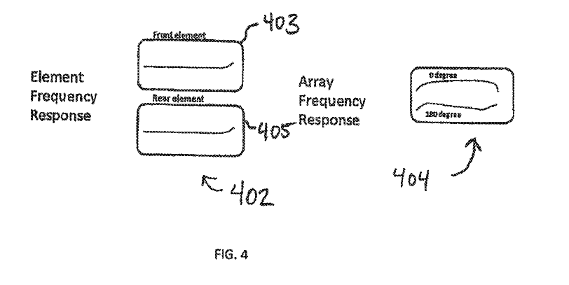

The present invention is a system having a microphone array for providing a unidirectional response to an audio signal or sound wave. Referring to FIG. 1, a circuit 100 is illustrated which is associated with a two-element axial array of two omni-directional microphones. In an embodiment, the sound ports (not shown) of the two elements 102, 104 are spaced apart by a distance of, for example, 15 mm. Other spacings may be achieved by varying the circuit delay. Sound originating from a source arrives at the ports of the two microphone elements 102, 104 with a time delay dependent on sound source position. The front microphone element 102 faces the preferred direction for sound reproduction from the two-element array; the rear microphone element 104 faces in an opposite direction. The microphone elements 102, 104 convert the sound pressure to voltage. At a first stage of the circuit 100, the resulting voltage is amplified via gain amplifiers 106, 108. A low-pass filter function is provided to pass audio frequencies at the gain stage 106 and 108. At a second stage of the circuit 100, an all-pass filter 112 provides frequency dependent delay of the rear microphone element signal. In the preferred embodiment, the delay is equal to the time required for sound to travel the distance between the sound ports. If, for example, the distance is 15 mm, the delay would be approximately 44 microseconds. In this manner, a cardioid directional response is achieved, as illustrated by the diagram in FIG. 2. FIG. 2 illustrates unidirectional patterns 200, 202 for sound sources on opposing sides of microphone elements 204, 206. FIG. 4 is a diagram which illustrates the element frequency response 402 of a front element 403 and a rear element 405 and the frequency response 404 of the axial microphone array circuit 100. Sound originating at 180 degress is typically received with amplitude at least 15 dB less compared to sound originating at 0 degrees.

In a third stage of the circuit 100, a bandpass filter 114 subtracts the signals from the front element 102 and the rear element 104, provides voltage gain, and also provides frequency filtering. In a fourth stage of the circuit 100, a converter 116 converts the output signal from the bandpass filter 114 to be compatible with a two-wire 12V connection. As, for example, would be typical for connection into an automotive system.

The front and rear microphone signals are switchable to allow reversal of the preferred direction for sound reproduction. A double-pole double-throw switch 105 controls which of the two microphone signals routes through the delay stage 112. The switch 105 may take many different forms. In a first embodiment, the switch 105 is in the form of a push-button type. In an example, the button may be pushed to alternate between receiving acoustic signals from a driver's side or passenger's side of a vehicle. In another embodiment, the switch 105 is voice-activated.

Prior art involving two-element first order unidirectional axial arrays required measures to compensate for amplitude and phase variability between microphone elements, such as, for example, electronic adjustments in gain and phase. Current MEMS microphones are typically well matched and do not require sorting or electronic measures to compensate for amplitude or phase variations between elements. Due to the restrictions of commercially available components, a switch of microphone inputs to achieve a reversed directional pattern in an array was not anticipated.

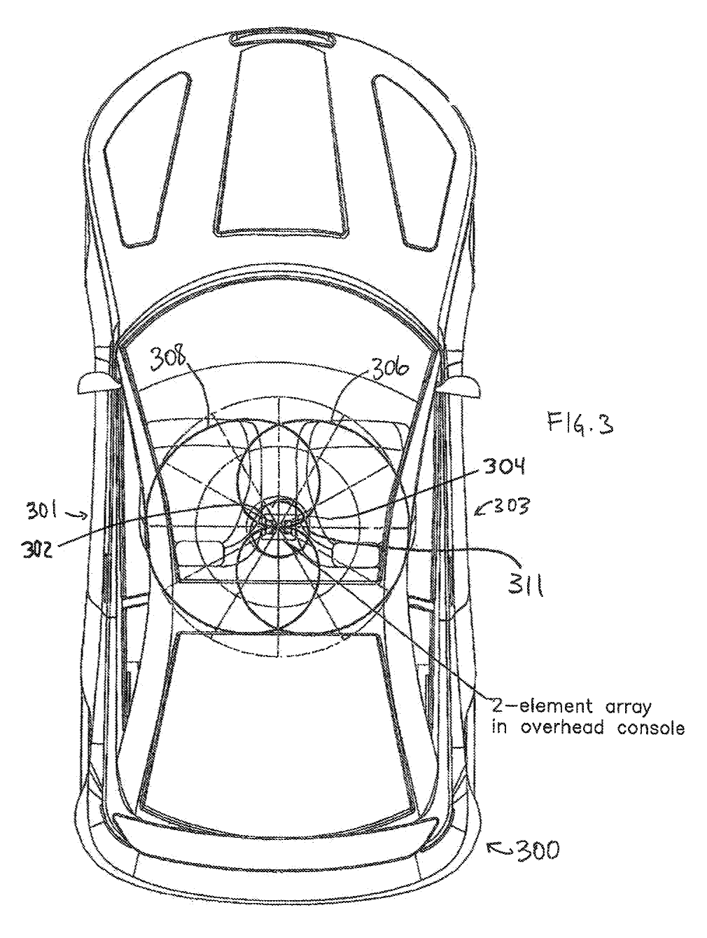

FIG. 3 illustrates the system of the present invention within an automobile 300. Microphone elements 302, 304 of array 311 provide cardioid patterns 306, 308 respectively. Accordingly, in an embodiment, when microphone element 302 is assigned as the front element of the array 311, the array 311 is responsive to a signal originating from a driver's side 301, whereas when microphone element 304 is assigned as the front element of the array 311, the array 311 is responsive to a signal originating from a passenger side 303. More specifically, a signal originating from a driver's side arrives sooner at microphone 302 than microphone 304. A delay may be created by the circuit 100 based on the distance between ports of microphone element 302 and microphone element 304.

It is contemplated that other systems are possible according to the present invention, such as, for example, systems having “n” elements which are pointed in “n” directions. A switch may be provided for selecting between each of the “n” elements, or selecting between combinations of the elements. The present invention may allow, for example, switching of acoustic signal detection in a situation in which two passengers are sitting on opposite sides of an automobile (i.e., driver's side and passenger's side). A first passenger may be speaking into, for example, a cellular phone. A second passenger may speak directly into the array situated between the passengers, and via means of the switch, may prevent the acoustic signals generated from the first passenger to be detected to the extent that those signals interfere the second passenger's acoustic signals. Additional elements may improve signal to noise ratio; and allow for higher order arrays with tighter directional patterns.

It will be appreciated that numerous variations to the above-mentioned approaches are possible. Variations to the above approaches may, for example, include performing the above steps in a different order.

All references, including publications, patent applications, and patents, cited herein are hereby incorporated by reference to the same extend as if each reference were individually and specifically indicated to be incorporated by reference and were set forth in its entirety herein.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A directional microphone system, the system comprising:
a first microphone having a first output, the first microphone disposed so as to receive sound energy originating from a first direction, the first microphone configured to convert the sound energy into a first voltage presented at the first output;
a second microphone having a second output, the second microphone disposed to receive sound energy from a second direction that is different than the first direction, the second microphone configured to convert the sound energy into a second voltage presented at the second output;
a first amplification circuit that is configured to provide a first voltage gain at a third output;
a second amplification circuit that is configured to provide a second voltage gain at a fourth output, the second amplification circuit configured to provide a predetermined time delay compared to the first amplification circuit;
a controlled switch that is configured to selectively switch a coupling of the first output between the first amplification circuit and the second amplification circuit and vice versa, the controlled switch further configured to selectively switch coupling of the second output between the second amplification circuit and the first amplification circuit and vice versa;
an output processing circuit coupled to the first amplification circuit and the second amplification circuit, the output processing circuit configured to subtract the fourth output from the third output such that a generally cardioid-shaped response is provided at an output of the output processing circuit.

2. The system of claim 1 wherein the output processing circuit comprises a filter and a converter.

3. The system of claim 2 wherein the converter is configured to convert received signals so as to be compatible with an electrical system.

4. The system of claim 3 wherein the predetermined electrical system is a two-wire, 12 V electrical system.

5. The system of claim 1 wherein the generally cardioid-shaped response provides a response with a first amplitude when the sound energy is received from a preferred direction and a response with second amplitude when the sound energy is received from a non-preferred direction, the first amplitude being substantially greater than the second amplitude.

6. The system of claim 1 wherein the delay is selected to be approximately the time sound travels between the first microphone and the second microphone.

7. The system of claim 1 wherein the controlled switch is selected from the group consisting of a push-button switch and a voice-activated switch.
